(19) United States
(12) Patent Application Publication
(10) Pub. No.: US 2020/0063655 A1
(43) Pub. Date: Feb. 27, 2020

(54) Crank Drive for a Reciprocating-Piston Engine and a Reciprocating Piston Engine with Such a Crank Drive

(71) Applicant: Bayerische Motoren Werke Aktiengesellschaft, Muenchen (DE)

(72) Inventor: Ulrich GUTZER, Muenchen (DE)

(21) Appl. No.: 16/671,283

(22) Filed: Nov. 1, 2019

Related U.S. Application Data
(63) Continuation of application No. PCT/EP2018/060129, filed on Apr. 20, 2018.

(30) Foreign Application Priority Data
May 4, 2017 (DE) 10 2017 207 464.7

(51) Int. Cl. F02B 75/04; F02D 15/02

(52) U.S. Cl. CPC F02B 75/048; F16C 3/06; F02D 15/02

(57) ABSTRACT

A crank drive for a reciprocating-piston engine includes a crankshaft which has at least one crank pin. At least one eccentric is rotatably arranged on the crank pin via which at least one connecting rod is to be rotatably mounted on the crank pin. A piston can be arranged so as to move in a translatory fashion in a cylinder having a variable compression ratio of the reciprocating-piston engine and can be coupled in an articulated fashion via the connecting rod to the crankshaft. At least one actuator shaft is arranged coaxially with respect to the crankshaft, by which actuator shaft the eccentric can be rotated relative to the crank pin by driving the actuator shaft. As a result, the compression ratio of the cylinder can be adjusted. An actuator element, by which the actuator shaft can be driven, is arranged at one end of the crankshaft and adjoins the actuator shaft in the axial direction of the crankshaft.

### CROSS REFERENCE TO RELATED APPLICATIONS

This application is a continuation of PCT International Application No. PCT/EP2018/060129, filed Apr. 20, 2018, which claims priority under 35 U.S.C. § 119 from German Patent Application No. 10 2017 207 464.7, filed May 4, 2017, the entire disclosures of which are herein expressly incorporated by reference.

### BACKGROUND AND SUMMARY OF THE INVENTION

The invention relates to a crank drive for a reciprocating piston engine, in particular for a motor vehicle, and to a reciprocating piston engine, in particular for a motor vehicle, having a crank drive of this type.

A crank drive for a reciprocating piston engine, in particular for a motor vehicle, and a reciprocating piston engine, in particular for a motor vehicle, having a crank drive of this type are already known, for example, from DE 10 2011 018 166 A1. Here, the reciprocating piston engine has at least one combustion chamber which is configured as a cylinder with a variable compression ratio, and a crankcase. Here, the crank drive comprises at least one piston which is received in the cylinder such that it can be moved translationally. This means that the piston can move to and fro translationally in the cylinder, with the result that the piston can be moved in the cylinder in an oscillating manner. Moreover, the crank drive comprises at least one connecting rod which is coupled to the piston in an articulated manner, which connecting rod is coupled to the piston in an articulated manner, for example, via a gudgeon pin. Furthermore, the crank drive comprises a crankshaft which is an output shaft of the reciprocating piston engine which is configured, for example, as an internal combustion engine. The reciprocating piston engine can provide torques via the crankshaft, in particular for driving the motor vehicle. Here, the crankshaft has at least one crankpin journal and at least one main bearing journal, via which the crankshaft is mounted on the crankcase such that it can be rotated relative to the crankcase about a crankshaft rotational axis. The crankshaft rotational axis is also called the crankshaft axis, the crankpin journal being arranged eccentrically with respect to the crankshaft axis.

Furthermore, the crank drive comprises at least one eccentric which is arranged rotatably on the crankpin journal and can therefore be rotated relative to the crankpin journal. Via the eccentric, the connecting rod is mounted rotatably on the crankpin journal, as a result of which the piston is coupled to the crankshaft in an articulated manner. By way of said articulated coupling of the piston to the crankshaft, the translational movements of the piston in the cylinder are converted into a rotational movement of the crankshaft about its crankshaft rotational axis.

Moreover, at least one actuating shaft is provided which is arranged coaxially with respect to the crankshaft and via which the eccentric can be rotated relative to the crankpin journal by way of driving of the actuating shaft. As a result, the compression ratio of the cylinder can be set. Furthermore, the crank drive comprises an actuator which is also called an actuating element. Here, the actuating shaft can be driven by means of the actuator and, as a consequence, the compression ratio can be set or can be changed.

It is an object of the present invention to provide a crank drive and a reciprocating piston engine of the type mentioned at the outset, with the result that particularly advantageous operation of the reciprocating piston engine can be realized.

A first aspect of the invention relates to a crank drive for a reciprocating piston engine, in particular of a motor vehicle such as a passenger car. The reciprocating piston engine is preferably configured as an internal combustion engine or as a combustion engine, it being possible, for example, for the motor vehicle which is configured, in particular, as a passenger car to be driven by means of the reciprocating piston engine. Here, the crank drive has a crankshaft which is an output shaft of the reciprocating piston engine. The reciprocating piston engine provides torque, in particular for driving the motor vehicle, for example via the crankshaft. Here, the crankshaft has at least one crankpin journal which is arranged, for example, eccentrically with respect to a main bearing journal of the crankshaft. Via the main bearing journal, for example, the crankshaft can be mounted rotatably on a crankcase of the reciprocating piston engine, with the result that the crankshaft can rotate relative to the crankcase about a crankshaft rotational axis (also called a crankshaft axis), in particular during operation and here, in particular, during combustion operation of the reciprocating piston engine.

Furthermore, the crank drive comprises at least one eccentric which is arranged rotatably on the crankpin journal. This means that the eccentric can be rotated relative to the crankpin journal. Via the eccentric, at least one connecting rod is mounted or can be mounted rotatably on the crankpin journal. Via the connecting rod, a piston of the reciprocating piston engine can be coupled or is coupled to the crankshaft in an articulated manner, the piston being arranged or being capable of being arranged in a translationally movable manner in a cylinder of the reciprocating piston engine, which cylinder has a variable compression ratio. In the finally manufactured state of the reciprocating piston engine, the piston can oscillate translationally in the cylinder. In other words, the piston can move to and fro translationally, the piston being connected to the connecting rod, for example, in an articulated manner. As a result, the piston is connected to the crankpin journal and therefore to the crankshaft overall via the connecting rod in an articulated manner, as a result of which the translational movements of the piston in the cylinder are converted into a rotational movement of the crankshaft about its crankshaft rotational axis.

During the abovementioned combustion operation, combustion processes proceed in the cylinder, within the context of which respective fuel/air mixtures are burned. As a result, the piston is driven, wherein the piston is moved in the cylinder translationally. As a result of the articulated coupling of the piston to the crankshaft, the crankshaft is rotated about its crankshaft rotational axis relative to the crankcase by way of the driving of the piston.

Furthermore, the crank drive comprises at least one actuating shaft which is arranged coaxially with respect to the crankshaft and is also called, for example, a synchronizing shaft. Via the actuating shaft, the eccentric can be rotated relative to the crankpin journal by way of driving of the actuating shaft, as a result of which the compression ratio of the cylinder can be set or can be adjusted. In other words, the actuating shaft is driven by way of the actuator (also called an actuating element), and the actuating shaft is thus rotated or turned, for example, about an actuating shaft rotational axis, in particular relative to the crankshaft. By way of the rotating of the actuating shaft about the actuating shaft rotational axis, the eccentric is rotated or turned, in particular at least indirectly, relative to the crankpin journal, in particular about an eccentric rotational axis. Since the eccentric, in particular its outer circumferential-side shell face, is eccentric with respect to the eccentric rotational axis which coincides, for example, with a center axis of the crankpin journal, the connecting rod is displaced in the radial direction of the crankpin journal relative to the latter by virtue of the fact that the eccentric is rotated about the eccentric rotational axis relative to the crankpin journal, as a result of which the compression ratio is changed. In particular, by way of rotation of the eccentric relative to the crankpin journal about the eccentric rotational axis, a stroke height of the piston can be changed, which correlates with a change in the compression ratio.

In order for it then to be possible for particularly advantageous and, in particular, low-emissions and low-energy consumption operation of the reciprocating piston engine to be realized, it is provided according to the invention that the actuator is arranged at one end of the crankshaft and adjoins the latter or the one end in the axial direction of the crankshaft. The background of the invention is, in particular, that the actuator is conventionally arranged either in the center of the motor or on the edge, and interacts at least indirectly with the eccentric or acts on the eccentric. This is to be understood to mean, in particular, that the actuator usually does not adjoin the crankshaft approximately in the axial direction thereof and is therefore not arranged at one end of the crankshaft, but rather the actuator is usually arranged in a plane which is intersected by the crankshaft. In order for it to be possible here for the compression ratio to be varied, a construction is required in an installation space which is usually provided for the crankshaft, in particular in the case of a reciprocating piston engine without a variable compression ratio. This leads to weakening of the crankshaft, in particular when the reciprocating piston engine is to remain unchanged in terms of its basic dimensions in comparison with a reciprocating piston engine without a variable compression ratio. Furthermore, a construction of this type can lead to decreases in the degree of efficiency, which can then be avoided, however, by means of the crank drive according to the invention. In other words, weakening of the crankshaft can be avoided by way of the described arrangement of the actuator at the one end of the crankshaft, with the result that, as a consequence, particularly efficient and therefore low-emissions and low-energy consumption, in particular low-fuel consumption, operation of the reciprocating piston engine which is preferably configured as an internal combustion engine can be produced.

The eccentric is configured, for example, as an eccentric bearing shell which can rotate relative to the crankpin journal in order to set or change the compression ratio. The changing or setting or adjusting of the compression ratio is also called compression adjustment. If, for example, a plurality of cylinders and therefore a plurality of crankpin journals and a plurality of eccentrics are provided, at least one synchronizing shaft is used, for example, for at least two of the plurality of eccentrics, via which synchronizing shaft the eccentrics which are provided for the respective cylinders are coupled to one another. The respective eccentric is usually turned via a non-rotating, rotatable shaft, as a result of which a phase angle of the eccentric is set. The non-rotating, rotatable shaft is to be understood to mean, in particular, that the shaft can be rotated about a setting rotational axis, in particular relative to the crankshaft, in order to set or to change the compression ratio as a result, but a rotation of the shaft does not take place while the crankshaft rotates about its crankshaft rotational axis and an adjustment of the compression ratio does not take place, that is to say the compression ratio remains constant. In contrast to this, in the case of the crank drive according to the invention, the actuating shaft can be configured as a rotating actuating shaft or synchronizing shaft which corotates permanently with the crankshaft about its actuating shaft rotational axis, while the crankshaft rotates about its crankshaft rotational axis and an adjustment of the compression ratio does not take place, that is to say the compression ratio remains at least substantially constant.

In one advantageous refinement of the invention, the actuating shaft penetrates at least one main bearing journal of the crankshaft completely in the axial direction of the crankshaft. Here, the actuating shaft preferably runs in the center of the main bearing journal, with the result that weakening of the crankshaft can be avoided.

It is preferably provided here that the at least one main bearing journal is the last main bearing journal of the crankshaft in the axial direction of the crankshaft. An arrangement of the actuator which is particularly favorable in terms of installation space can be realized as a result, with the result that undesired weakening of the crankshaft can be avoided.

In the case of a further advantageous embodiment of the invention, the actuator is arranged coaxially with respect to the crankshaft, as a result of which particularly efficient operation can be realized.

It has been shown to be particularly advantageous if the actuator can be rotated about a rotational axis, in particular relative to the crankshaft, in order to drive the actuating shaft. It is preferably provided here that the rotational axis of the actuator coincides with the abovementioned actuating shaft rotational axis of the actuating shaft.

In the case of one particularly advantageous embodiment of the invention, the rotational axis of the actuator coincides with the crankshaft rotational axis, about which the crankshaft can be rotated, in particular relative to the crankcase, during operation of the reciprocating piston engine.

It has been shown to be particularly advantageous, furthermore, if the actuator corotates with the crankshaft permanently about the rotational axis, while the crankshaft rotates about its crankshaft rotational axis and an adjustment of the compression ratio is not carried out, that is to say the compression ratio is constant. In other words, it is provided that, when the crankshaft rotates about its crankshaft rotational axis and an adjustment of the compression ratio does not take place, the actuator corotates with the crankshaft permanently or continually about the rotational axis of the actuator. Therefore, the actuator is preferably configured as a rotating actuator, via the rotational speed of which, for example, a phase angle of the eccentric which is preferably configured as a bearing shell can be set relative to the crankpin journal. By way of this, the compression ratio can finally be set.

It has been shown to be particularly advantageous here if the rotating actuator corotates with the crankshaft at a fixed rotational speed ratio to the crankshaft in the case of a constant compression ratio. Here, for example, an energy flow takes place to the actuator which can therefore operate, for example, as a generator. Here, for example, the actuator is driven by the crankshaft via the actuating shaft. It is conceivable here to operate the actuator as a generator, by means of which, for example, mechanical energy which is provided by the actuating shaft can be converted into electric energy. Said electric energy can be provided, for example, it being possible for the provided electric energy to be fed at least substantially directly to at least one electric consumer and/or to be stored in an energy store.

Furthermore, it is contemplated that an energy flow can take place from the actuator, in particular to the actuating shaft, the actuator then operating as a motor, for example. This is provided, for example, in order to set or adjust the compression ratio. Therefore, for example, the actuator can be operated as an electric motor, in order to drive the actuating shaft. A wide variety of setting options result, in particular, in the case of a rotating actuator, in particular control options; the set rotational speed ratio between the rotating actuator and the crankshaft should be compatible, however, with the overall mechanism, in particular with regard to plain bearings.

Furthermore, it is contemplated that the actuator is configured as a non-rotating, rotatable actuator. This is to be understood to mean that a rotation of the actuator about the rotational axis of the actuator does not take place, while the crankshaft rotates about its crankshaft rotational axis and an adjustment of the compression ratio does not take place. In order to change the compression ratio, however, the actuator is rotated about its rotational axis, in particular relative to the crankshaft.

In order for it to be possible for particularly efficient operation to be realized and for the compression ratio to be set in a particularly needs-oriented and precise manner, it is preferably provided that the actuator is configured as an internal gear of a planetary gear mechanism. Here, the planetary gear mechanism comprises the internal gear, a sun gear, a planetary carrier and at least one planetary gear which meshes with the sun gear and with the internal gear and is mounted rotatably on the planetary carrier. The planetary carrier is, for example, also called a spider.

It has been shown to be particularly advantageous here if the planetary carrier is connected fixedly to the crankshaft so as to rotate with it. As a result, particularly efficient operation can be produced.

It has been shown to be particularly advantageous, furthermore, if the sun gear is connected fixedly to the actuating shaft so as to rotate with it. As a result, the compression ratio can be set in a particularly advantageous manner, in particular by virtue of the fact that the internal gear is turned, in particular relative to the crankshaft. The sun gear and, with it, the actuating shaft are turned by way of turning of the internal gear, in particular via the planetary gear, as a result of which the compression ratio can be set in a needs-oriented and precise manner.

Finally, it has been shown to be particularly advantageous if a worm drive is provided, by means of which the internal gear can be driven and can be rotated as a result, by way of which the actuating shaft can be driven. The worm drive is also called a worm gear mechanism and preferably has a self-locking action, with the result that, for example when it is desired to not change the compression ratio but rather to keep it constant, the internal gear is secured by way of the worm drive, in particular by way of its self-locking action, against a rotation about the rotational axis of the actuator. Therefore, no additional actuators such as brakes or clutches are required, in order to avoid an undesired rotation of the actuator (of the internal gear) and therefore an undesired adjustment of the compression ratio, but rather this takes place by way of the worm drive and, in particular, by way of its self-locking action. As a result, the number of parts, the weight and the installation space requirement of the crank drive can be kept particularly low, with the result that particularly efficient operation can be realized.

A second aspect of the invention relates to a reciprocating piston engine for a motor vehicle, which reciprocating piston engine is preferably configured as an internal combustion engine, having at least one cylinder having a variable compression ratio, having a crankcase and having a crank drive, in particular in accordance with the first aspect of the invention.

Here, the crank drive of the second aspect of the invention has at least one piston which is received in the cylinder such that it can be moved translationally, and at least one connecting rod which is coupled to the piston in an articulated manner. Moreover, the crank drive has a crankshaft having at least one crankpin journal and at least one main bearing journal, via which the crankshaft is mounted on the crankcase such that it can be rotated relative to the crankcase about a crankshaft rotational axis. Moreover, the crank drive comprises at least one eccentric which is arranged rotatably on the crankpin journal and via which the connecting rod is mounted rotatably on the crankpin journal, as a result of which the piston is coupled to the crankshaft in an articulated manner. As a consequence, the translational movements of the piston in the cylinder can be converted into a rotational movement of the crankshaft about its crankshaft rotational axis. Furthermore, the crank drive comprises at least one actuating shaft which is arranged coaxially with respect to the crankshaft and via which the eccentric can be rotated relative to the crankpin journal by way of driving of the actuating shaft, as a result of which the compression ratio of the cylinder can be set or can be adjusted or can be changed. Moreover, the crank drive comprises an actuator, by means of which the actuating shaft can be driven.

In order for it then to be possible for particularly efficient and therefore low-emissions and low-energy consumption operation to be realized, it is provided according to the invention that the actuator is arranged at one end of the crankshaft and adjoins the crankshaft in the axial direction of the crankshaft. Advantages and advantageous refinements of the first aspect of the invention are to be considered to be advantages and advantageous refinements of the second aspect of the invention, and vice versa.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a diagrammatic side view of a crank drive according to the invention for a reciprocating piston engine in accordance with a first embodiment.

FIG. 2 shows details of a diagrammatic side view of the crank drive in accordance with a second embodiment.

In the figures, identical or functionally identical elements are provided with identical designations.

### DETAILED DESCRIPTION OF THE DRAWINGS

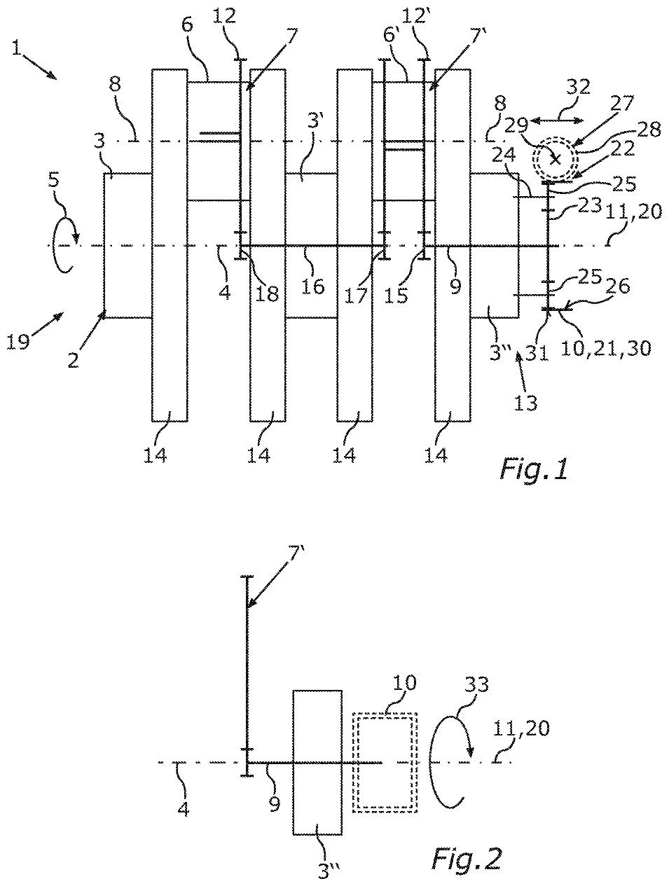

FIG. 1 shows a diagrammatic side view of a first embodiment of a crank drive 1 for a reciprocating piston engine, in particular of a motor vehicle. The motor vehicle is configured, for example, as a car, in particular as a passenger car, and can be driven by means of the reciprocating piston engine. Here, the reciprocating piston engine is configured as an internal combustion engine or as a combustion engine, and comprises at least one combustion chamber which is configured as a cylinder. In particular, the reciprocating piston engine has a plurality of cylinders. Moreover, the reciprocating piston engine has a crankcase which is configured, for example, as a cylinder crankcase and by way of which, for example, the cylinders are formed. As will be described in greater detail in the following text, the respective cylinder has a variable compression ratio, the value of which changes and can therefore be set. Per cylinder, for example, the crank drive 1 has a piston which is not shown in the figure, is received in the respective cylinder such that it can be moved translationally, and can move to and fro translationally in the cylinder. During combustion operation of the reciprocating piston engine, the respective cylinder is supplied with fuel, in particular liquid fuel, for operating the reciprocating piston engine and with air, with the result that fuel/air mixtures are produced in the respective cylinder. The respective fuel/air mixtures are ignited and burned as a result, by way of which the relative cylinder is driven, that is to say is moved translationally relative to the crankcase.

Here, per piston, the crank drive 1 comprises a connecting rod which is coupled to the respective piston in an articulated manner, is not shown in the figures, and is coupled to the respective piston in an articulated manner, for example, via a gudgeon pin. As a result, the translational movements of the piston can be transmitted to the respective connecting rod.

Moreover, the crank drive 1 comprises a crankshaft 2 which has a plurality of main bearing journals 3, 3′ and 3″ which in the axial direction of the crankshaft 2 are arranged such that they are spaced apart from one another and follow one another. Via the main bearing journals 3, 3′ and 3″, the crankshaft 2 is mounted rotatably on the crankcase, with the result that the crankshaft 2 can rotate relative to the crankcase about a crankshaft rotational axis 4. This rotatability of the crankshaft 2 about the crankshaft rotational axis 4 relative to the crankcase is illustrated by way of an arrow 5 in FIG. 1.

Furthermore, in particular per cylinder, the crankshaft 2 has a crankpin journal 6 or 6′ which is arranged eccentrically with respect to the crankshaft rotational axis 4 and therefore carries out a stroke when the crankshaft 2 rotates relative to the crankcase about the crankshaft rotational axis 4. Here, an eccentric 7 or 7′ is mounted or arranged rotatably on the respective crankpin journal 6 or 6′, with the result that the respective eccentric 7 or 7′ can rotate about an eccentric rotational axis 8 relative to the respective crankpin journal 6 or 6′. It can be seen particularly clearly from FIG. 1 that the eccentric rotational axis 8 runs at least substantially parallel to the crankshaft rotational axis 4 and is spaced apart or offset here from the crankshaft rotational axis 4.

Via the respective eccentric 7 or 7′, the respective connecting rod is mounted rotatably on the respective crankpin journal 6 or 6′, as a result of which the piston is coupled in an articulated manner to the respective crankpin journal 6 or 6′ and therefore to the crankshaft 2 overall via the gudgeon pin, the connecting rod and the respective eccentric 7 or 7′. By way of said articulated coupling of the respective piston to the crankshaft 2, the respective translational movements of the respective piston can be converted into a rotational movement of the crankshaft 2 about its crankshaft rotational axis 4. If, as described above, the respective piston is therefore driven, the crankshaft 2 is driven as a consequence and is therefore rotated about its crankshaft rotational axis 4 relative to the crankcase. As a result, the reciprocating piston engine can provide torques for driving the motor vehicle via the crankshaft 2 in combustion operation.

Furthermore, the crank drive 1 comprises at least one actuating shaft 9 which is arranged coaxially with respect to the crankshaft 2 or with respect to the crankshaft rotational axis 4 and via which the respective eccentric 7 or 7′ can be turned relative to the respective crankpin journal 6 or 6′ by way of driving of the actuating shaft 9. As a result, the compression ratio of the respective cylinder can be set. Moreover, at least one actuator 10 which is also called an actuating element is provided, by means of which the actuating shaft 9 can be driven. By way of driving of the actuating shaft 9, the latter is rotated about an actuating shaft rotational axis 11, in particular relative to the crankshaft 2 and relative to the crankcase, the actuating shaft rotational axis 11 coinciding with the crankshaft rotational axis 4. By way of rotation of the actuating shaft 9 about the actuating shaft rotational axis 11, the respective eccentric 7 or 7′ is turned about the eccentric rotational axis 8 relative to the respective crankpin journal 6 or 6′, as a result of which the compression ratio of the respective cylinder is changed. Here, the compression ratio is changed in such a way that the respective eccentric 7 or 7′, in particular its outer circumferential-side shell face, is of eccentric configuration with regard to the eccentric rotational axis 8. Here, the eccentric rotational axis 8 coincides, for example, with a center axis of the respective crankpin journal 6 or 6′. If the respective eccentric 7 or 7′ is therefore rotated about the eccentric rotational axis 8 relative to the respective crankpin journal 6 or 6′, the respective connecting rod and therefore the respective piston are displaced as a result in the radial direction of the respective crankpin journal 6 or 6′ relative to the respective crankpin journal 6 or 6′, as a result of which, for example, a stroke height of the piston and therefore the respective compression ratio of the respective cylinder are set or changed.

Here, for example, the respective eccentric 7 or 7′ is configured as an eccentric bearing shell, via which the respective connecting rod is mounted rotatably on the respective crankpin journal 6 or 6′. It can be seen from FIG. 1, in particular, that the main bearing journals 3, 3′ and 3″ are connected to the crankpin journals 6 and 6′ via respective crank webs 14. In order for it to be possible for the respective eccentric 7 or 7′ to be turned relative to the crankpin journal 6 or 6′, the respective eccentric 7 or 7′ has, for example, a toothing system 12 or 12′ which is configured as an external toothing system and the function of which will be described in greater detail in the following text.

In order for it then to be possible for excessive weakening of the crankshaft 2 which is brought about by way of the use of the variable compression ratio to be avoided and, as a consequence, for particularly efficient and therefore low-emissions and low-fuel consumption operation of the reciprocating piston engine to be realized, the actuator 10 is arranged at one end 13 of the crankshaft 2 and adjoins the crankshaft 2, in particular the end 13, in the axial direction of the crankshaft 2. Here, the axial direction of the crankshaft 2 coincides with the crankshaft rotational axis 4.

It can be seen from FIG. 1 that the actuating shaft 9 is connected fixedly with a gearwheel 15 so as to rotate with it, which gearwheel 15 meshes with the toothing system 12′ and therefore with the eccentric 7′. If the actuating shaft 9 is therefore rotated about the actuating shaft rotational axis 11, in particular relative to the crankshaft 2, the eccentric 7′ is driven by the gearwheel 15 and, as a result, is turned about the eccentric rotational axis 8 relative to the crankpin journal 6′.

The actuating shaft 9 is also called a synchronizing shaft. Here, the crank drive 1 comprises a further synchronizing shaft 16 which is also called an actuating shaft, is connected fixedly to gearwheels 17 and 18 so as to rotate with them, and can be rotated about the actuating shaft rotational axis 11, in particular relative to the crankshaft 2. Here, the synchronizing shaft 16 is also arranged coaxially with respect to the crankshaft 2. The gearwheel 17 meshes with the toothing system 12′ which is configured as an external toothing system and therefore with the eccentric 7′, with the result that, when the eccentric 7′ is rotated about the eccentric rotational axis 8 relative to the crankpin journal 6′, the gearwheel 17 and the synchronizing shaft 16 are rotated about the actuating shaft rotational axis 11 relative to the crankshaft 2. Here, the gearwheel 18 is also rotated about the actuating shaft rotational axis 11 relative to the crankshaft 2, since the gearwheel 18 is connected fixedly to the synchronizing shaft 16 so as to rotate with it. Here, the gearwheel 18 meshes with the toothing system 12 which is configured as an external toothing system, and therefore with the eccentric 7, with the result that the eccentric 7 is turned about the eccentric rotational axis 8 relative to the crankpin journal 6 by way of rotation of the gearwheel 18 about the actuating shaft rotational axis 11 relative to the crankshaft 2. The eccentrics 7 and 7′ are therefore coupled to one another via the gearwheels 17 and 18 and the synchronizing shaft 16, in particular are coupled fixedly to one another so as to rotate together, with the result that the eccentrics 7 and 7′ are rotated at the same time or synchronously about the eccentric rotational axis 8 relative to the crankpin journals 6 and 6′ when the actuating shaft 9 is rotated by means of the actuator 10 about the actuating shaft rotational axis 11, in particular relative to the crankshaft 2. The actuating shaft 9 is therefore a synchronizing shaft which is provided in addition to the synchronizing shaft 16 and to which the actuator 10 which is arranged at the end 13 which is also called the crankshaft end is attached, in particular at least indirectly.

It can be seen from FIG. 1 that the actuating shaft 9 runs in the center of the main bearing journal 3″ and in the process penetrates the main bearing journal 3″ completely in the axial direction of the crankshaft 2. This means that the actuating shaft 9 protrudes out of or protrudes beyond the main bearing journal 3″ at both ends or on both sides in the axial direction of the crankshaft 2. Here, the main bearing journal 3″ is the last main bearing journal of the crankshaft 2 in the axial direction of the crankshaft 2, in particular on the side of the end 13. At that end 19 of the crankshaft 2 which lies opposite the end 13 in the axial direction of the crankshaft 2, said crankshaft 2 has the main bearing journal 3. Here, the synchronizing shaft 16 is arranged in the center of the main bearing journal 3′ and penetrates the latter completely in the axial direction of the crankshaft 2. As a result, excessive weakening of the crankshaft 2 can be avoided.

Furthermore, it can be seen particularly clearly from FIG. 1 that the actuator 10 is arranged coaxially with respect to the crankshaft 2, and can be rotated here about a rotational axis 20, in particular relative to the crankshaft 2 and/or relative to the crankcase. Here, the rotational axis 20 of the actuator 10 coincides with the crankshaft rotational axis 4, the rotational axis 20 of the actuator 10 also being called the actuator rotational axis. It can be seen overall that the crankshaft rotational axis 4, the actuating shaft rotational axis 11 and the rotational axis 20 of the actuator 10 coincide. In order to set the compression ratio and therefore to rotate the eccentric 7 and 7′, the actuator 10 is rotated about the rotational axis 20 (actuator rotational axis), in particular relative to the crankshaft 2 and/or relative to the crankcase.

In the case of the first embodiment which is shown in FIG. 1, the actuator is configured as a non-rotating, rotatable actuator which, although it can be rotated or is rotated about the rotational axis 20, in order to change the compression ratio, a rotation of the actuator 10 about the rotational axis 20 is not carried out while the crankshaft 2 rotates about the crankshaft rotational axis 4, and the compression ratio remains constant or an adjustment of the compression ratio is not carried out. Therefore, for example, the actuator 10 rotates about the rotational axis 20 only for rotating the eccentrics 7 and 7′, that is to say only for adjusting the compression ratio. In the case of the refinement of the actuator 10 as a non-rotating actuator, advantageous, correct relative rotational speeds can be ensured, and the actuator 10 is at a standstill in the case of a constant compression ratio.

Furthermore, in the case of the first embodiment, the actuator 10 is configured as an internal gear 21 of a planetary gear mechanism 22. Here, the planetary gear mechanism 22 comprises the internal gear 21 (actuator 10), a sun gear 23, a planetary carrier 24 which is also called a spider, and at least one or more planetary gears 25 which mesh with the sun gear 23 and with the internal gear 21 and are mounted rotatably on the planetary carrier 24. Here, the internal gear 21 has a first toothing system in the form of an internal toothing system 26 which meshes with the planetary gears 25. Here, the planetary carrier 24 is configured fixedly with respect to the crankshaft, that is to say is connected fixedly to the crankshaft 2 so as to rotate with it. The sun gear 23 is connected fixedly to the actuating shaft 9 so as to rotate with it, with the result that the actuating shaft 9 and therefore the gearwheel 15 are rotated about the rotational axis 20 or about the actuating shaft rotational axis 11, in particular relative to the crankshaft 2 and/or relative to the crankcase, by way of rotation of the sun gear 23 about the rotational axis 20. Therefore, the sun gear 23 is rotated about the rotational axis 20 in order to adjust the compression ratio. To this end, the internal gear 21 is in turn rotated about the rotational axis 20.

In order to rotate the internal gear 21 about the rotational axis 20, a drive 27 is provided, by means of which the internal gear 21 can be driven and, as a result, can be rotated about the rotational axis 20. In the case of the first embodiment which is illustrated in FIG. 1, the drive 27 is configured as a worm drive which has what is known as a worm 28. The worm 28 can be rotated about a worm rotational axis 29 relative to the crankcase and, in particular, relative to the crankshaft 2, the worm rotational axis 29 running perpendicularly with respect to an imaginary plane, and the rotational axis 20 lying in the imaginary plane or running parallel to the imaginary plane. Furthermore, the worm drive comprises a worm gear 30 which meshes with the worm 28 and, as a result, can be rotated about the rotational axis 20, such that the worm 28 is rotated about the worm rotational axis 29. It can be seen here from FIG. 1 that the worm gear 30 is formed by way of the internal gear 21. To this end, for example, the internal gear 21 has a second toothing system in the form of an external toothing system 31 which is configured, for example, as a helical toothing system. Here, the worm 28 meshes with the external toothing system 31 or engages into the external toothing system 31, with the result that, as is generally known from worm drives or worm gear mechanisms, the worm gear 30 or the internal gear 21 is rotated about the rotational axis 20 when the worm 28 is rotated about the worm rotational axis 29. This is illustrated by way of a double arrow 32 in FIG. 1.

In order to drive and therefore rotate the worm 28 about the worm rotational axis 29, for example, a motor which cannot be seen in the figures is provided which is configured, for example, as an electric motor. The use of the worm drive is advantageous in so far as the worm drive has a self-locking action or enters into a self-locking state when the worm 28 is not rotated actively about the worm rotational axis 29 by means of the motor. As a result, in the case of a constant compression ratio, the internal gear 21 does not have to be secured by way of additional and separate actuators or brakes against an undesired rotation about the rotational axis 20 by means of the worm drive, with the result that an undesired change of the compression ratio can be avoided by way of the self-locking action of the worm drive and therefore in a particularly inexpensive manner.

FIG. 2 shows a second embodiment of the crank drive 1. The second embodiment differs, in particular, from the first embodiment in that the actuator 10 is not configured as a rotatable, non-rotating actuator, but rather as a rotatable, rotating actuator, which is illustrated by way of an arrow 33 in FIG. 2. The rotatable, rotating actuator 10 is to be understood to mean that the actuator corotates permanently with the crankshaft 2 about the rotational axis 20, in particular with a fixed rotational speed ratio to the crankshaft 2, while the crankshaft 2 rotates about its crankshaft rotational axis 4, and an adjustment of the compression ratio is not carried out. Here, furthermore, a relative rotation between the actuator 10 and the crankshaft 2 is not carried out, for example. In order to change the compression ratio, the actuator 10 is turned about the rotational axis 20 relative to the crankshaft 2. If, however, the compression ratio remains constant, the actuator 10 rotates with the crankshaft 2 about the rotational axis 20. This results in a wide variety of control options; respective rotational speed ratios which are set should be compatible, however, with the overall mechanism, in particular with regard to plain bearings.

### LIST OF DESIGNATIONS

1 Crank drive
2 Crankshaft
3, 3′, 3″ Main bearing journal
4 Crankshaft rotational axis
5 Arrow
6, 6′ Crankpin journal
7, 7′ Eccentric
8 Eccentric rotational axis
9 Actuating shaft
10 Actuator
11 Actuating shaft rotational axis
12, 12′ External toothing system
13 End
14 Crank web
15 Gearwheel
16 Synchronizing shaft
17 Gearwheel
18 Gearwheel
19 End
20 Rotational axis
21 Internal gear
22 Planetary gear mechanism
23 Sun gear
24 Planetary carrier
25 Planetary gear
26 Internal toothing system
27 Drive
28 Worm
29 Worm rotational axis
30 Worm gear
31 External toothing system
32 Double arrow
33 Arrow

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A crank drive for a reciprocating piston engine, comprising:
a crankshaft having at least one crankpin journal;
at least one eccentric arranged rotatably on the crankpin journal and via which a connecting rod is mounted rotatably on the crankpin journal, by which connecting rod a piston arrangeable so as to move translationally in a cylinder having a variable compression ratio is couplable to the crankshaft in an articulated manner;
at least one actuating shaft arranged coaxially with respect to the crankshaft and via which the eccentric is rotatable relative to the crankpin journal by driving the actuating shaft, as a result of which the compression ratio of the cylinder is settable; and
an actuator by which the actuating shaft is driven, wherein
the actuator is arranged at one end of the crankshaft and adjoins the crankshaft in an axial direction of the crankshaft.

2. The crank drive according to claim 1, wherein
the actuating shaft penetrates at least one main bearing journal of the crankshaft completely in the axial direction of the crankshaft.

3. The crank drive according to claim 2, wherein
the at least one main bearing journal is the last main bearing journal of the crankshaft in the axial direction of the crankshaft.

4. The crank drive according to claim 1, wherein
the actuator is arranged coaxially with respect to the crankshaft.

5. The crank drive according to claim 1, wherein
the actuator is rotatable about a rotational axis relative to the crankshaft, in order to drive the actuating shaft.

6. The crank drive according to claim 4, wherein
the rotational axis of the actuator coincides with a crankshaft rotational axis about which the crankshaft is rotatable relative to a crankcase during operation of the reciprocating piston engine.

7. The crank drive according to claim 5, wherein
the actuator corotates with the crankshaft permanently about the rotational axis, while the crankshaft rotates about its crankshaft rotational axis and an adjustment of the compression ratio is not carried out.

8. The crank drive according to claim 7, wherein
the actuator corotates with the crankshaft permanently about the rotational axis at a fixed rotational speed ratio to the crankshaft, while the crankshaft rotates about its crankshaft rotational axis and an adjustment of the compression ratio is not carried out.

9. The crank drive according to claim 5, wherein
a rotation of the actuator about the rotational axis is not carried out, while the crankshaft rotates about its crankshaft rotational axis and an adjustment of the compression ratio is not carried out.

10. The crank drive according to claim 1, wherein
the actuator is configured as an internal gear of a planetary gear mechanism which has the internal gear, a sun gear, a planetary carrier and at least one planetary gear which meshes with the sun gear and with the internal gear and is mounted rotatably on the planetary carrier.

11. The crank drive according to claim 10, wherein
the planetary carrier is connected fixedly to the crankshaft so as to rotate with the crankshaft.

12. The crank drive according to claim 10, wherein
the sun gear is connected fixedly to the actuating shaft so as to rotate with the actuating shaft.

13. The crank drive according to claim 10, wherein
a worm drive is provided by which the internal gear is driven and is rotated as a result by way of which the actuating shaft is driven.

14. A reciprocating piston engine for a motor vehicle, comprising:
at least one cylinder which has a variable compression ratio;
a crankcase; and
a crank drive comprising:
at least one piston which is received in the cylinder such that the piston is movable translationally;
at least one connecting rod which is coupled to the piston in an articulated manner;
a crankshaft having at least one crankpin journal and having at least one main bearing journal, via which the crankshaft is mounted on the crankcase such that the crankshaft is rotatable relative to the crankcase about a crankshaft rotational axis;
at least one eccentric which is arranged rotatably on the crankpin journal and via which the connecting rod is mounted rotatably on the crankpin journal, as a result of which the piston is coupled to the crankshaft in an articulated manner;
at least one actuating shaft which is arranged coaxially with respect to the crankshaft and via which the eccentric is rotatable relative to the crankpin journal by way of driving of the actuating shaft, as a result of which the compression ratio of the cylinder is settable; and
an actuator, by which the actuating shaft is driven, wherein the actuator is arranged at one end of the crankshaft and adjoins the crankshaft in the axial direction of the crankshaft.
